(19) United States
(12) Patent Application Publication
(10) Pub. No.: US 2006/0135694 A1
(43) Pub. Date: Jun. 22, 2006

(54) Hot melt adhesive composition

(76) Inventors: Steven R. Vaughan, Chisago Lake Township, MN (US); Carlos Briseno, St. Paul, MN (US); Merilee M. Reski, Woodbury, MN (US)

Correspondence Address: H.B. Fuller Patent Dept., 1200 Willow Lake Blvd., P.O. Box 64683, St. Paul, MN, 55164-0683, US

(21) Appl. No.: 11/303,660

(22) Filed: Dec. 16, 2005

Related U.S. Application Data
(60) Provisional application No. 60/636,922, filed on Dec. 17, 2004.

(51) Int. Cl. C08L 53/00

(52) U.S. Cl. 525/88

(57) ABSTRACT

A hot melt adhesive composition includes ethylene vinyl acetate copolymer(s) having average vinyl acetate content of from about 10% to about 30%, styrene-ethylene-butylene-styrene block copolymer, tackifying resin, and optionally, a plasticizer or a wax.

The invention relates to a hot melt adhesive composition including ethylene vinyl acetate copolymer(s), styrene-ethylene-butylene-styrene block copolymer, tackifying resin, and optionally plasticizer(s) and/or wax.

Hot melt adhesives have been used for the construction of disposable articles such as disposable diapers, sanitary napkins, surgical drapes, hospital pads, and adult incontinent products, etc. Disposable articles are typically composed of several components that are bonded together by various hot melt adhesives. Depending on the function of components the hot melt adhesives used for bonding one component of the article may be completely unsuitable for bonding another component of the article.

One particular component of the disposable article includes a polyolefin film e.g., a polyethylene or polypropylene film, bonded to a tissue or nonwoven substrate through a hot melt construction adhesive to form a leakage-prevention sheet to prevent permeation of fluids. It is desirable that hot melt adhesives used therein would have very good adhesion to nonwoven substrates, high heat stability, proper open time, flexibility, odorless and colorless. Low viscosity is also desirable for low temperature application. Lower application temperature makes it possible to use lighter weight and lower melting films in disposable articles.

Ethylene vinyl acetate copolymer based hot melt adhesives have been used in bonding plastic or polyolefin films, e.g., polyethylene films, to tissue or nonwoven substrates in construction of disposable articles. While providing the desirable heat stability and flexibility to the bonded substrates, ethylene vinyl acetate copolymer based hot melt construction adhesives exhibit insufficient adhesion in spray applications. They also tend to build viscosity slowly as they cool causing application problems. Namely bleeding or soaking through the nonwoven substrate and causing adhesive build up on the machines. Styrenic block copolymer (SBC) such as styrene-isoprene-styrene (SIS) or styrene-butadiene-styrene (SBS) based hot melt adhesives have also been used to bond polyolefin films to nonwoven substrates. These adhesives have improved adhesion in spray applications compared to ethylene vinyl acetate based adhesives. Styrenic block copolymers tend to build viscosity quickly as they cool which reduces the amount they bleed through or soak though the nonwoven substrate. However formulations that have low enough viscosities to be applied at low application temperatures such as no greater than about 135° C. tend to contain a high amount of liquid plasticizer causing these adhesives to be cohesively weak and have a tendency to continue to flow at room temperature or slightly above room temperature. This can cause disposable articles to stick together under storage or shipping conditions.

With the vinyl acetate functionality in its molecules, ethylene vinyl acetate copolymers are more polar in nature whereas styrenic block copolymers are non-polar. Therefore, the two different copolymers have been considered as incompatible. That is, when mixed together, one could not obtain a clear or transparent, homogeneous mixture of the two copolymers, but rather a cloudy and non-transparent or non-homogeneous one indicating a phase separation. Without the desirable compatibility, it has been a challenge in the art to formulate a hot melt adhesive including both ethylene vinyl acetate copolymer and styrenic block copolymer that is not only compatible but also has well balanced properties such as desirable heat stability, low viscosity suitable for applications at low temperatures, high adhesion and cohesive strength, as well as no bleed through.

### SUMMARY OF THE INVENTION

In one aspect, the invention features a hot melt adhesive composition that includes ethylene vinyl acetate copolymer(s) having average vinyl acetate content of from about 10% to about 30% based on the weight of the copolymer(s), styrene-ethylene-butylene-styrene (SEBS) block copolymer(s) having average styrene content of from about 10% to about 25% based on the weight of the block copolymer(s), and a tackifying resin, provided that if one of the average vinyl acetate content and the average styrene content is no less than about 20%, the other of the average vinyl acetate content and the average styrene content is no greater than about 20%.

In some embodiments, the average vinyl acetate content and the average styrene content may both be no greater than about 20%. In some embodiments, the average vinyl acetate content is greater than about 20% while the avarage styrene content is less than about 20%. In some embodiments, the average vinyl acetate content is less than about 20% while the average styrene content is greater than about 20%. The adhesive composition is formulated such that it exhibits very good compatibility. In some embodiments, the adhesive composition exhibits consistent compatibility after aging at 135° C. for 96 hours. In some embodiments the adhesive composition exhibits consistent compatibility after aging at 177° C. for 96 hours.

In one embodiment, the invention features a hot melt adhesive composition that includes ethylene-vinyl acetate copolymer(s) having average vinyl acetate content of from about 10% to about 30% based upon the weight of the copolymer(s) and a melt index (or combined melt index) of no less than 40 g/10 min; styrene-ethylene-butylene-styrene block copolymer(s) having average styrene content of from about 10% to about 30% based upon the weight of the block copolymer(s); and a tackifying resin.

In another embodiment, the invention features a hot melt adhesive composition that includes ethylene-vinyl acetate copolymer(s) having average vinyl acetate content of from about 10% to about 30% based upon the weight of the copolymer(s); styrene-ethylene-butylene-styrene block copolymer (s) having average styrene content of from about 10% to about 30% based upon the weight of the block copolymer(s); and a tackifying resin. The adhesive composition has a melt viscosity of no greater than 7,000 cps at 135° C.

In an embodiment for bookbinding applications, the adhesive composition has a melt viscosity of no greater than 10,000 cps at 177° C.

In another embodiment, the invention features a hot melt adhesive composition that includes ethylene-vinyl acetate copolymer(s) having average vinyl acetate content of from about 10% to about 20% based upon the weight of the copolymer(s); styrene-ethylene-butylene-styrene block copolymer having a peak weight molecular weight of no greater than about 90,000 and styrene content of from about 25% to about 30% based upon the weight of the copolymer; and a tackifying resin.

In some embodiments, the above-mentioned adhesive compositions further include at least one plasticizer. In some embodiments, the above-mentioned adhesive compositions further include at least one wax.

In some embodiments, the above-mentioned adhesive compositions further include a styrenic block copolymer chosen from styrene-isoprene-styrene, styrene-butadiene-styrene, styrene-ethylene-propylene-styrene, and combinations thereof.

The present invention features a hot melt adhesive composition that exhibits very well balanced properties such as good and consistent compatibility, low viscosity, high heat stability, good adhesion, good cohesive strength, and substantially free of bleed through.

The adhesive composition exhibits excellent heat stability at application temperatures such as no greater than about 135° C. In some embodiments, the adhesive composition exhibits excellent heat stability at application temperatures such as about 177° C. Heat stability is determined by percentage change (% change) in melt viscosity, and compatibility change after adhesive composition being aged at 135° C. for 96 hours, relative to the initial melt viscosity and compatibility at 135° C. prior to aging. In some embodiments, the adhesive composition exhibits no greater than about 10% change in melt viscosity after aging at 135° C. for a period of 96 hours relative to the initial melt viscosity at 135° C. prior to aging. In other embodiments, the adhesive composition exhibits no greater than 6% change in melt viscosity after aging at 135° C. for a period of 96 hours relative to the initial melt viscosity at 135° C. prior to aging. In one embodiment, the adhesive composition exhibits no greater than 3% change in melt viscosity after aging at 135° C. for a period of 96 hours relative to the initial melt viscosity at 135° C. prior to aging. In some embodiments, the adhesive composition remains clear or transparent, and homogeneous, i.e., free of cloud or haze and smooth after aging at 135° C. for 96 hours, indicating no phase separation, or incompatibility. In some embodiments for bookbinding applications, heat stability is determined by percentage change (% change) in melt viscosity, and compatibility change after adhesive composition being aged at 177° C. for 96 hours, relative to the initial melt viscosity and compatibility at 177° C. prior to aging. In some embodiments, the adhesive composition exhibits no greater than about 10% change in melt viscosity after aging at 177° C. for a period of 96 hours relative to the initial melt viscosity at 177° C. prior to aging. In other embodiments, the adhesive composition exhibits no greater than 5% change in melt viscosity after aging at 177° C. for a period of 96 hours relative to the initial melt viscosity at 177° C. prior to aging. In some embodiments, the adhesive composition remains clear or transparent, and homogeneous, i.e., free of cloud or haze and smooth after aging at 177° C. for 96 hours, indicating no phase separation, or incompatibility.

The adhesive composition exhibits very good adhesion. In some embodiments, the adhesive composition exhibits initial spiral spray peel strength of no less than about 70 grams. In other embodiments, the adhesive composition exhibits initial spiral spray peel strength of no less than about 80 grams. In some embodiments, the adhesive composition exhibits initial spiral spray peel strength of no less than about 90 grams

The adhesive composition exhibits good cohesive strength. In some embodiments, the adhesive composition exhibits initial fine line peel strength of no less than about 70 grams. In other embodiments, the adhesive composition exhibits initial fine line peel strength of no less than about 80 grams. In some embodiments, the adhesive composition exhibits initial fine line peel strength of no less than about 90 grams.

The adhesive composition exhibits substantially free of bleed-through, i.e., no greater than about 30 grams bleed-through as measured according to adhesive bleed-through test method. In some embodiments, the adhesive composition exhibits no greater than about 30 grams bleed-through. In some embodiments, the adhesive composition exhibits no greater than about 20 grams bleed-through. In some embodiments, the adhesive composition exhibits no greater than about 15 grams bleed-through.

In another aspect, the invention features an article that includes a first substrate and an adhesive composition of the invention disposed on the substrate. In some embodiments, the first substrate is chose from polyolefin films such as polyethylene film, polypropylene film, polyester film; nonwoven fabrics; paper or coated paper, and combinations thereof.

In another aspect, the invention features a method of constructing an article that includes contacting a first substrate with an adhesive composition of the invention. The adhesive composition can be applied using conventional hot melt coating equipments. In some embodiments, the adhesive composition is well suited to application at low temperatures of no greater than about 135° C. In some embodiments such as for bookbinding applications, the adhesive composition can be applied at relatively high temperature such as about 177° C.

Other features and advantages will be apparent from the following description of the preferred embodiments and from the claims.

### Glossary

In reference to the invention, these terms have the meanings set forth below:

“Compatibility” and “compatible” mean the molten solution of the adhesive, which is molten at 135° C., or at 177° C. for some embodiments, is clear, free from cloudiness or haze; and homogeneous and smooth, free of lumps or gel, and shows no evidence of phase separation or layers.

“Ethylene vinyl acetate copolymer(s)” refers to one or more ethylene vinyl acetate copolymers. In case more than one copolymer are used in the adhesive composition, each ethylene vinyl acetate copolymer would have different vinyl acetate content and melt index.

“Styrene-ethylene-butylene-styrene block copolymer (s)” refers to one or more styrene-ethylene-butylene-styrene block copolymers. In case more than one styrene-ethylene-butylene-styrene block copolymer(s) are used in the adhesive composition, each styrene-ethylene-butylene-styrene block copolymer would have different styrene content.

“Average vinyl acetate content” refers to the vinyl acetate content of the ethylene vinyl acetate copolymer(s) used in the adhesive composition, based on the total weight of the ethylene vinyl acetate copolymer(s) in the adhesive composition. If more than one ethylene vinyl acetate copolymer(s) are used in the adhesive composition, and each copolymer has different vinyl acetate content the average vinyl acetate content is the average of vinyl acetate content of the blend of ethylene vinyl acetate copolymers based on the total weight of the blend of ethylene vinyl acetate copolymers used in the adhesive composition. Average vinyl acetate content is calculated using the following formula:

VA %=(weight % of polymer A of the total EVA content) (VA % of polymer A)+(weight % of polymer B of the total EVA content) (VA % of polymer B) For example, the average vinyl acetate content of a blend of 50% by weight polymer A (vinyl acetate content: 18%) and 50% by weight polymer B (vinyl acetate content: 28%) is calculated as follows:

$$\begin{matrix}VA \% = ( 0.5 ) ( 18 ) + ( 0.5 ) ( 28 ) \\ = ( 9 ) + ( 14 ) = 23\end{matrix}$$

“Average styrene content” refers to the styrene content of the styrene-ethylene-butylene-styrene block copolymer(s) used in the adhesive composition, based on the total weight of the styrene-ethylene-butylene-styrene block copolymer(s) in the adhesive composition. If more than one styrene-ethylene-butylene-styrene block copolymers are used in the adhesive composition, and each block copolymer has different styrene content, the average styrene content is the average of the styrene content of the blend of styrene-ethylene-butylene-styrene block copolymers based on the total weight of the blend of the styrene-ethylene-butylene-styrene block copolymers used in the adhesive composition. Average styrene content is calculated in the same way as the above calculation for average vinyl acetate content.

“Melt index (MI)” refers to the combined melt index of the ethylene vinyl acetate copolymer(s) used in the adhesive composition based on the total weight of the ethylene vinyl acetate copolymer(s). The combined melt index is calculated using the following formula: log MI blend=((weight fraction polymer A) (log MI A))+((weight fraction polymer B) (log MI B)).

For example, the combined melt index of a blend of 50% by weight polymer A (3 MI) and 50% by weight polymer B (150 MI) is calculated as follows:

$$\begin{matrix}log MI blend = ( 0.5 \times log 3 ) + ( 0.5 \times log 150 ) \\ = ( 0.5 \times 0.4771 ) + ( 0.5 \times 2.1761 ) \\ = 1.3263\end{matrix}$$

$$MI blend = antilog 1.3263 or 21.2$$

“Bleed-through” is a measure of the amount of adhesive that has bled or soaked through a nonwoven substrate at 120° F. as described in the adhesive bleed-through test method.

### DETAILED DESCRIPTION OF THE INVENTION

Hot melt adhesive composition of the invention includes specific ethylene vinyl acetate copolymer(s), styrene-ethylene-butylene-styrene block copolymer(s), and at least one tackifying resin.

Hot melt adhesive composition is a clear and homogeneous blend of its various ingredients. In some embodiments, the adhesive composition has a clear appearance in the molten state at about 135° C., it is transparent and smooth, free of cloudiness or haze and of grainy at about 135° C. In some embodiments, the adhesive composition has a clear appearance in the molten state at about 177° C., it is transparent and smooth, free of cloudiness or haze and of grainy at about 177° C.

The adhesive composition may have a viscosity such that it can be applied using various conventional hot melt application methods and/or processing equipments at application temperatures e.g., no greater than about 177° C., or no greater than about 150° C. In some embodiments, the adhesive composition have a viscosity such that it can be applied using conventional hot melt processing equipments at lower application temperatures e.g., no greater than about 135° C., or, no greater than about 120° C., or, even at about 100° C. In some embodiments, the adhesive composition has a melt viscosity of no greater than about 10,000 centipoises at about 177° C. In some embodiments, the adhesive composition has a melt viscosity of no greater than about 7,000 centipoises at about 135° C. In some embodiments, the adhesive composition has a melt viscosity of no greater than about 5,000 centipoises at about 135° C. In some embodiments, the adhesive composition has a melt viscosity of no greater than about 4,000 centipoises at about 135° C. The melt viscosity of the adhesive composition could be as low as about 1,000 centipoises, or as low as about 2,000 centipoises at about 135° C.

In some embodiments, hot melt adhesive composition is substantially hydrophobic. That is, the adhesive has a surface tension of less than 34 dynes/cm². Alternatively, the adhesive is substantially free of surfactant(s). That is, the adhesive has less than about 0.5% by weight surfactant(s). In some embodiments, the adhesive has less than about 0.3% by weight surfactant(s). In some embodiments, the adhesive is free of surfactant(s).

Ethylene vinyl acetate copolymer(s) in the adhesive composition preferably has an average vinyl content of from about 10% to about 30% based on the weight of the copolymer(s). In one embodiment, ethylene vinyl acetate copolymer(s) has average vinyl acetate content of from about 10% to about 25%. In some embodiments, ethylene vinyl acetate copolymer(s) has average vinyl acetate content of from about 10% to about 20%.

Useful ethylene vinyl acetate copolymers may have a melt index of no greater than about 500 g/10 min, or no greater than about 400 g/10 min. In other embodiments, ethylene vinyl acetate copolymer(s) may have a melt index of no greater than about 200 g/10 min. In some embodiments, ethylene vinyl acetate copolymer(s) may have a melt index of no less than about 40 g/10 min. In some other embodiments, ethylene vinyl acetate copolymer(s) may have a melt index of no less than about 60 g/10 min. In some embodiments, ethylene vinyl acetate copolymer(s) may have a melt index of no less than about 80 g/10 min.

Examples of commercially available ethylene vinyl acetate copolymers include such as Elvax® 350 from Dupont (Wilmington, Del.), Escurene® 7520 from Exxon, (Huston, Tex.), and Ateva® 1850A from AT Plastics (Edmonton, Alberta, Canada).

The adhesive composition preferably includes at least about 5% by weight, or at least about 7% by weight, no greater than about 30% by weight, or no greater than about 20% by weight, or no greater than about 15% by weight ethylene vinyl acetate copolymer(s) based on the total weight of the adhesive composition.

Suitable styrene-ethylene-butylene-styrene block copolymer(s) preferably has average styrene content of from about 10% to about 30% based on the weight of the block copolymer(s). In some embodiments, the styrene-ethylene-butylene-styrene block copolymer(s) preferably has average styrene content of from about 10% to about 25%. In some embodiments, the styrene-ethylene-butylene-styrene block copolymer(s) preferably has average styrene content of from about 10% to about 20%. In some embodiments, the styrene-ethylene-butylene-styrene block copolymer(s) preferably has average styrene content of from about 10% to about 15%. In other embodiments, the styrene-ethylene-butylene-styrene block copolymer(s) preferably has average styrene content of from about 25% to about 30%.

The molecule weight of the styrene-ethylene-butylene-styrene block copolymer may also contribute to the compatibility of the adhesive. In some embodiments, the styrene-ethylene-butylene-styrene block copolymer may have a peak weight molecule weight (Mw) of no greater than about 120,000. In some embodiments, the styrene-ethylene-butylene-styrene block copolymer may have a peak weight molecule weight (Mw) of no greater than about 100,000. In other embodiments, the styrene-ethylene-butylene-styrene block copolymer may have a peak weight molecule weight (Mw) of no greater than about 90,000. In other embodiments, the styrene-ethylene-butylene-styrene block copolymer may have a peak weight molecule weight (Mw) of no less than about 50,000, or no less than about 60,000. In some embodiments where the styrene-ethylene-butylene-styrene block copolymer has a styrene content of greater than about 25%, the peak weight molecule weight (Mw) of the block copolymer is no greater than about 90,000 so that the adhesive composition is more compatible.

Examples of commercially available styrene-ethylene-butylene-styrene block copolymers include such as Kraton® G series, such as Kraton® G 1650, 1652, 1657 from Kraton Polymer (Houston, Tex.), and Septon® 8007 from Kuraray (Pasadena, Tex.). The adhesive composition preferably includes at least about 3% by weight, no greater than about 20% by weight, or no greater than about 15% by weight, or no greater than about 10% by weight styrene-ethylene-butylene-styrene block copolymer based on the total weight of the adhesive composition.

Useful tackifying resins include, e.g., any compatible hydrocarbon resin, synthetic polyterpene, rosin esters, natural terpenes, and the like. More particularly, and depending upon the particular base polymer, the useful tackifying resins include (1) natural and modified rosins; (2) glycerol and pentaerythritol esters of natural and modified rosins; (3) copolymers and terpolymers of natural terpenes; (4) polyterpene resins having a softening point, as determined by ASTM method E28-58T, of 80° C. to 150° C.; (5) phenolic modified terpene resins and hydrogenated derivatives thereof; (6) aliphatic petroleum hydrocarbon resins having a Ball and Ring softening point of 70° C. to 135° C.; (7) aromatic petroleum hydrocarbon resins and the hydrogenated derivatives thereof; (8) alicyclic petroleum hydrocarbon resins and the hydrogenated derivatives thereof; (9) aromatic/aliphatic or alicyclic hydrocarbon resins such as those sold under the trademarks ECR 149B and ECR 179A by Exxon Chemical Company; and combinations thereof. Tackifying resins disclosed in U.S. Pat. No. 6,288,149, which is incorporated by reference in its entirety, may also be useful.

Examples of useful commercially available tackifying resins include Escorez 2596 C₅ aliphatic resins and Escorez 5600 aromatic dicyclopentadiene resins, and Escorez 5400, which are available from Exxon Chemical (Houston, Tex.), Zonatac 105LT styrenated terpene tackifying resins available from Arizona Chemical (Jacksonville, Fla.), and Eastotac H-130R aliphatic tackifying resins available from Eastman Chemical (Kingsport, Tenn.).

The adhesive composition of the invention may include from about 30% by weight to about 65% by weight, preferable from about 45% by weight to about 60% by weight, of the tackifying resin(s) based on the total weight of the adhesive composition.

The adhesive composition of the invention may optionally include from about 15% by weight to about 35% by weight of a plasticizer based on the total weight of the adhesive composition. Useful plasticizers are preferable those that are liquid at ambient temperature, also known as liquid plasticizers, such as plasticizing oils. In the context of the present invention a liquid plasticizer is also defined as a flow able diluent having a weight average molecular weight (Mw) of less than 3,000, preferably less than 2,000, and more preferably less than 1000. Suitable plasticizing oils are primarily hydrocarbon oils low in aromatic content. Preferably, the oils are paraffinic or naphthenic in character. The oils are preferably clear, low in volatility and have as little color and odor as possible. The use of plasticizing oils in the present invention also contemplates the use of lolefin oligomers, low molecular weight polymers, vegetable oils and their derivatives and similar plasticizing liquids.

Examples of commercially available plasticizers include Kaydol 35 from Witco Corporation (Greenwich Conn.), Calsol 5 series from Calumet Lubicants Company (Indianapolis, Ind.).

Other useful plasticizers include crystallizing plasticizers including, e.g., Benzoflex 352 (1,4-cyclohexanedimethanl dibenzoate, dicyclohexyl phthalate, Benzoflex S404 1,2,3-propane trioltribenzoate, and Benzoflex S552 1,3-propanediol, 2,2-bis[(benzoyloxy)methyl], dibenzoate, all from Velsicol Chemical Company (Chicago, Ill.). Plasticizers disclosed in U.S. Pat. No. 6,288,149 and U.S. Pat. No. 6,531,544, both are incorporated by reference in their entirety, may also be useful.

The adhesive composition may include up to about 5% by weight, based on the total weight of the adhesive composition, a styrenic block copolymer such as styrene-isoprene-styrene, styrene-butadiene-styrene, styrene-ethylene-propylene-styrene, or combinations thereof.

The adhesive composition may optionally include up to about 40% by weight of wax, based on the total weight of the adhesive composition. In some embodiments, the adhesive composition may include from about 5% by weight to about 40% by weight, or from about 5% by weight to about 35% by weight, or from about 10% by weight to about 30% by weight of wax. In some embodiments, the adhesive composition may include up to about 5% by weight wax. In some embodiments, the adhesive composition is substantially free of wax. That is, the adhesive composition may include no greater than about 1% by weight wax. In some embodiments, the adhesive composition is free of wax.

The adhesive composition may also include other optional components such as antioxidants, fillers, pigments, dyestuffs, processing aids, and combinations thereof.

The adhesive composition can be prepared by blending the components in the melt at a temperature of from about 100° C. to about 200° C. until a homogeneous blend is obtained. Various blending methods are known in the art and any method that could produce a homogeneous blend would be suitable.

The adhesive composition is suitable for bonding polyolefin films such as polyethylene or polypropylene film to tissue, woven or nonwoven fabrics, or to other polyethylene or polypropylene films using any suitable conventional application techniques such as spraying, coating, laminating, melt blown and combination thereof. The adhesive composition is also suitable for use in the bookbinding industry such as one or two shot bookbinding, cover gluing, backlining, tightbacking, side gluing, joint gluing, casemaking, etc. The adhesive composition is also suitable for use in the packaging industry such as case and carton sealing and tray formation. These packages may be manufactured from materials such as virgin and recycled kraft, high and low density kraft, chipboard and various types of treated and coated kraft and chipboard, and corrugated versions of the materials; composite materials such as chipboard laminated with an aluminum foil that may further laminated to film materials such as polyethylene, mylar, polypropylene, polyvinylidene chloride, ethylene vinyl acetate, etc. The film materials may laminate directly with chipboard or kraft without aluminum foil.

In another aspect, the invention features an article including at least one substrate and a hot melt adhesive composition of the invention disposed on the substrate. The substrate can be a polyolefin film such as polyethylene film, polypropylene film, polyester film, woven or nonwoven fabrics, tissue, paper pulp fibers, paper, coated paper, paperboards cardboard, and combination thereof. Examples of the article include such as a disposable article e.g., disposable diapers, feminine protection articles, incontinent pads, bed pads, surgical drapes and gowns, and the like. Such articles are typically made by bonding a polyolefin film such as a polyethylene film to a nonwoven substrate using a hot melt construction adhesive that may be applied by a continuous layer of adhesive, a patterned layer of adhesive, or an array of separate lines, spirals, or spots of adhesive depending on the application methods. Examples of the article also include such as carton, case, tray, book blocks, books, book cases, etc.

The invention will now be described by way of the following examples. The amounts indicated are in percent by weight unless otherwise indicated.

### EXAMPLES

Test Procedures

Test procedures used in the examples include the following.

Compatibility

Compatibility is determined by visual inspection as follows:

The adhesive sample is molten at 135° C., or 177° C. The molten adhesive is then visually inspected. A compatible adhesive should look clear and transparent, free from clouds, haze; homogeneous and smooth, free from lumps or gels and separation layers. The adhesive is then kept in a forced air oven for 96 hours and visually inspected again thereafter. A compatible adhesive should appear substantially the same as the initial unaged adhesive.

The result of the inspection is designated as “O” if the adhesive is clear and smooth (good compatibility), as “⊖” if the adhesive has slight cloudiness but smooth (acceptable compatibility), and as X if the adhesive has cloudiness and grainy or even lumpy (incompatible).

Melt Viscosity

A hot melt adhesive is molten by heating and the viscosity at a test temperature (such as 135° C., or 177° C.) is measured by using Brookfield thermocel viscometer.

Heat Stability

Heat Stability is determined by % change in viscosity and compatibility change as follows:

300 g of a hot melt adhesive in a beaker is molted in a forced air oven at 135° C., or 177° C. The initial melt viscosity is measured once the adhesive is molten. Compatibility is also estimated by visual inspection. Then, the adhesive is kept in the oven at 135° C., or 177° C., for 96 hours. Thereafter, the melt viscosity is measured again. % change in viscosity is calculated relative to the initial melt viscosity. Compatibility is estimated again by visual inspection.

Spiral Spray Peel Strength

Laminate 1 mil polyethylene film to nonwoven fabric using a 0.5 inch wide spiral spray pattern and an adhesive coat weight of 6.2 grams. Cut the lamination into 1 inch by 4 inch test coupon with the spiral spray pattern centered in the 1 inch cross-machine direction of the coupon. Peel the test coupon at a tensile speed of 12 inch/min. Both average tensile strength (ATS) and peak tensile strength (PTS) are measured on each of the seven (7) sample coupons. Reporting the average ATS of the seven (7) samples as the spiral spray peel strength.

Fine Line Peel Strength Laminate 1 mil polyethylene film to nonwoven fabric using 1 bead of adhesive at a coat weight of 0.055 g/m. Cut the lamination into 1 inch by 4 inch test coupon with the adhesive bead centered in the 1 inch cross-machine direction of the coupon. Peel the test coupon at a tensile speed of 12 inch/min. Both average tensile strength (ATS) and peak tensile strength (PTS) are measured on each of the seven (7) sample coupons. Reporting the average ATS of the seven (7) samples as the fine line peel strength.

Adhesive Bleed-Through

Make polyethylene film nonwoven fabric lamination using 1 bead of adhesive with a coating weight of 0.055 g/m. Cut the lamination into 1 inch by 5 inch test coupons. Place the test coupons nonwoven side down on a 1 inch by 5 inch piece of polyethylene film. Place this test sample in an oven at 120° F. and place a weight of 875 g per square inch on the test sample for 1 hour. Then remove the sample from the oven and allow it to cool for 15 minutes. Peel the polyethylene film from the lamination at a rate of 12 inch/min. Both average tensile strength (ATS) and peak tensile strength (PTS) are measured on each of the seven (7) sample coupons. Reporting the average PTS of the seven (7) samples as the bleed-through.

Peak Weight Molecular Weight

Peak weight molecular weight of the styrene-ethylene-butylene-styrene block copolymer is measured according to ASTM D-5296-92.

Peel and Shear

Peel and shear values are determined by placing samples in a programmed oven with 100 g weight used for the peel mode and 500 g weight used for the shear mode, and ramping the temperature up from about 25° C. to 175° C. at 25° C./hour. The oven automatically recorded the temperature at which the samples failed. Each sample was coated onto kraft paper by hand using glass rods or shims. The resultant coating is a one inch wide band that is about 8-10 mils or about 0.02 cm to about 0.03 cm thick. Four to five bonds were made for the peel mode and four to five bonds were made for the shear mode and the results were averaged.

Cold Crack

Films with a thickness of 20-30 mils are prepared by hand using a glass rod or shim. Several samples that are 2.54 cm (1 inch) by 7.62 cm (3 inches) are cut from the film. The samples are placed on a base in a freezer at 10° C. for one hour. The base is made from a rigid plastic and has a trough that is cut into the base at a 90 degree angle. After one hour a pressure bar, that is cut to exactly fit the base, is forced into the samples. The cold crack is the temperature at which the 1 inch by 3 inch sample fails. The temperature is decreased by about 2.8° C. every hour until the adhesive fails.

### Experimental Examples 1-12

Various styrenic block copolymers (SBC) and ethylene vinyl acetate copolymers (EVA) are blended together at about 350° F. at EVA/SBC weight ratio of 1.75:1 according to Table I. The initial compatibility of each of the blends is visually inspected and the results are reported in Table I. Each blend is aged at 135° C. for 96 hours and the final compatibility is again visually inspected. The results are also reported in Table I.

### Examples 1-14

Hot melt adhesive compositions of each of Examples 1-14 are prepared by combining and melting the ingredients in the amounts (% by weight) specified in Table II at 350° F. Various properties of the adhesive compositions of Examples 1-14 are then tested according to the test methods described above. The results of the tests are also reported in Table II.

### Examples 15 and 16

Hot melt adhesive compositions of each of Examples 15 and 16 are prepared by combining and melting the ingredients in the amounts (% by weight) specified in Table III at 177° C. Various properties of the adhesive compositions of Examples 15 and 16 are then tested according to the test methods described above. The results of the tests are also reported in Table III.

Other embodiments are within the claims.

TABLE I

| Experimental | | % | | % | Initial | Initial | Clarity | Texture | Compatibility |
|---|---|---|---|---|---|---|---|---|---|
| Example | SBC | STYRENE | EVA | VA | Clarity | Texture | after aging | after aging | after aging |
| 1 | Kraton ® G-1652 | 29 | 18-150 | 18 | Clear | Smooth | Clear | Smooth | ◯ |
| 2 | Kraton ® G-1652 | 29 | 28-400 | 28 | Cloudy | Smooth | — | Phase | X |
| | | | | | | | | separation | |
| 3 | Kraton ® G-1650 | 29 | 18-150 | 18 | Cloudy | Grainy | Cloudy | Grainy | X |
| 4 | Kraton ® G-1657 | 13 | 18-150 | 18 | Clear | Smooth | Clear | Smooth | ◯ |
| 5 | Vector ® 4111 (SIS) | 18 | 18-150 | 18 | Cloudy | Slightly | — | Phase | X |
| | | | | | | Grainy | | separation | |
| 6 | Vector ® 4111 | 18 | 28-400 | 28 | Cloudy | Slightly | Cloudy | Slightly | X |
| | | | | | | Grainy | | grainy | |
| 7 | Vector ® 4211 (SIS) | 28 | 18-150 | 18 | Cloudy | Smooth | — | Phase | X |
| | | | | | | | | separation | |
| 8 | Finaprene ® 401 (SBS) | 20 | 18-150 | 18 | Cloudy | Lumpy | — | Phase | X |
| | | | | | | | | separation | |
| 9 | Finaprene ® 401 (SBS) | 20 | 28-400 | 28 | Cloudy | Lumpy | — | Phase | X |
| | | | | | | | | separation | |
| 10 | Kraton ® 1102 (SBS) | 28 | 18-150 | 18 | Cloudy | Slightly | — | Phase | X |
| | | | | | | Grainy | | separation | |
| 11 | Kraton ® G-1650 | 29 | 8-9 | 08 | Cloudy | Grainy | Cloudy | Grainy | X |
| 12 | Kraton ® G-1652 | 29 | 18-150 | 23 | Cloudy | Smooth | Cloudy | Slightly | X |
| | | | 28-05 | | | | | Grainy | |

TABLE II

| | Ex. 1 | Ex. 2 | Ex. 3 | Ex. 4 | Ex. 5 |
|---|---|---|---|---|---|
| EVA 28-06 | | | | | |
| EVA 28-03 | | | 7 | | |
| EVA 12-03 | 14 | 10 | | | |
| EVA 13-220 | | | | | |
| EVA 33-43 | | | | | |
| EVA 18-150 | | | 7 | 5 | 5 |
| EVA 08-09 | | | | 5 | 5 |
| Vector ® | | | | | |
| 4111 (18% | | | | | |
| Styrene | | | | | |
| SIS) | | | | | |
| Kraton ® | 8 | 8 | 8 | 7 | 8 |
| G1657 (13% | | | | | |
| Styrene | | | | | |
| SEBS) | | | | | |
| Escorez ® | 51 | 51 | 51 | 54 | 51 |
| 5400 | | | | | |
| (tackifying | | | | | |
| Resin) | | | | | |
| Nyflex 222B | 25.65 | 29.65 | 25.65 | 27.65 | 29.65 |
| (plasticizer) | | | | | |
| BNX 1010 | 0.1 | 0.1 | 0.1 | 0.1 | 0.1 |
| (antioxident) | | | | | |
| RM-6313 | 1 | 1 | 1 | 1 | 1 |
| (processing | | | | | |
| aid) | | | | | |
| ZeroPack ® | 0.25 | 0.25 | 0.25 | 0.25 | 0.25 |
| Film (pro- | | | | | |
| cessing aid) | | | | | |
| Application | | | | | |
| temperature | | | | | |
| (° C.) | | | | | |
| MI of EVA | 3 | 3 | 21 | 37 | 37 |
| (g/10 min) | | | | | |
| Average | 12.0 | 12.0 | 23.0 | 13.0 | 13.0 |
| vinyl | | | | | |
| acetate % | | | | | |
| % Styrene | 13.0 | 13.0 | 13.0 | 13.0 | 13.0 |
| Initial peel | 28 | 38 | 56 | 55 | 52 |
| strength | (8) | (10) | (3) | (2) | (2) |
| (spiral | | | | | |
| spray) | | | | | |
| (grams) | | | | | |
| 2 weeks at | 47 | 65 | 130 | 47 | 75 |
| 50° C. | (10) | (7) | (17) | (3) | (5) |
| 4 weeks at | | | | | |
| 50° C. | | | | | |
| Initial peel | 98 | 81 | 79 | 86 | 69 |
| strength | (47) | (4) | (13) | (15) | (15) |
| (fine line) | | | | | |
| (grams) | | | | | |
| 2 weeks at | 163 | 119 | 92 | 105 | 84 |
| 50° C. | (26) | (32) | (13) | (18) | (7) |
| 4 weeks at | | | | | |
| 50° C. | | | | | |
| Viscosity | | | | | |
| (cps) at | | | | | |
| 93° C. | | | | | |
| Viscosity | | | | | |
| (cps) at | | | | | |
| 107° C. | | | | | |
| Viscosity | | | | | |
| (cps) at | | | | | |
| 121° C. | | | | | |
| Viscosity | 10,525 | 6,750 | | 3,225 | 3,700 |
| (cps) at | | | | | |
| 135° C. | | | | | |
| Viscosity | 6,250 | 3,750 | | 1,860 | 2,250 |
| (cps) at | | | | | |
| 150° C. | | | | | |
| % Viscosity | | | | | |
| Change | | | | | |
| Compatibility | | | | | |
| after aging | | | | | |
| at 135° C. | | | | | |
| Adhesive | | | 12 | 4 | 2 |
| Bleed- | | | (8) | (3) | (4) |
| through | | | | | |
| Machine | No | No | No | No | No |
| Build-up | | | | | |

| | Ex. 6 | Ex. 7 | Ex. 8 | Ex. 9 | Ex. 10 |
|---|---|---|---|---|---|
| EVA 28-06 | | 2.732 | | | |
| EVA 28-03 | | | | | |
| EVA 12-03 | | | | | |
| EVA 13-220 | 6.191 | | | | |
| EVA 33-43 | | | 7.038 | | |
| EVA 18-150 | | 7.268 | 2.962 | 10 | 8 |
| EVA 08-09 | 3.809 | | | 4 | 2 |
| Vector ® | | | | | |
| 4111 (18% | | | | | |
| Styrene, | | | | | |
| SIS) | | | | | |
| Kraton ® | 7 | 7 | 7 | 8 | 8 |
| G1657 (13% | | | | | |
| Styrene, | | | | | |
| SEBS) | | | | | |
| Escorez ® | 54 | 54 | 54 | 51 | 51 |
| 5400 | | | | | |
| (Tackifying | | | | | |
| Resin) | | | | | |
| Nyflex 222B | 27.65 | 27.65 | 27.65 | 25.65 | 29.65 |
| (plasticizer) | | | | | |
| BNX 1010 | 0.1 | 0.1 | 0.1 | 0.1 | 0.1 |
| (Antioxident) | | | | | |
| RM-6313 | 1 | 1 | 1 | 1 | 1 |
| (processing | | | | | |
| aid) | | | | | |
| ZeroPack ® | 0.25 | 0.25 | 0.25 | 0.25 | 0.25 |
| Film (pro- | | | | | |
| cessing aid) | | | | | |
| Application | 127 | 127 | 127 | | 121 |
| temperature | | | | | |
| (° C.) | | | | | |
| MI of EVA | 62 | 62 | 62 | 67 | 86 |
| (g/10 min) | | | | | |
| Average | 11.5 | 20.7 | 28.5 | 15.1 | 16.0 |
| vinyl | | | | | |
| acetate % | | | | | |
| % Styrene | 13.0 | 13.0 | 13.0 | 13.0 | 13.0 |
| Initial peel | 94 | 96 | 111 | 55 | 76 |
| strength | (4) | (5) | (6) | (5) | (4) |
| (spiral | | | | | |
| spray) | | | | | |
| (grams) | | | | | |
| 2 weeks at | 129 | 126 | 135 | 96 | 111 |
| 50° C. | (9) | (70 | (7) | (10) | (6) |
| 4 weeks at | 125 | 144 | 149 | | 128 |
| 50° C. | (20) | (12) | (11) | | (28) |
| Initial peel | 76 | 78 | 75 | 82 | 103 |
| strength | (9) | (8) | (10) | (6) | (8) |
| (fine line) | | | | | |
| (grams) | | | | | |
| 2 weeks at | 128 | 88 | 75 | 116 | 86 |
| 50° C. | (32) | (5) | (16) | (21) | (4) |
| 4 weeks at | 151 | 99 | 86 | | 86 |
| 50° C. | (12) | (13) | (12) | | (2) |
| Viscosity | | | | | |
| (cps) at | | | | | |
| 93° C. | | | | | |
| Viscosity | | | | | |
| (cps) at | | | | | |
| 107° C. | | | | | |
| Viscosity | 5,250 | 5,000 | 5,500 | | 5,750 |
| (cps) at | | | | | |
| 121° C. | | | | | |
| Viscosity | | | | | 3,250 |
| (cps) at | | | | | |
| 135° C. | | | | | |
| Viscosity | 1,700 | 1,625 | 1,725 | | |
| (cps) at | | | | | |
| 150° C. | | | | | |
| % Viscosity | | | | | |
| Change | | | | | |
| Compatibility | ◯ | ◯ | Θ | | |
| after aging | | | | | |
| at 135° C. | | | | | |
| Adhesive | | | | 2 | 9 |
| Bleed- | | | | (4) | (12) |
| through | | | | | |
| Machine | No | No | No | No | No |
| Build-up | | | | | |

| | Ex. 11 | Ex. 12 | Ex. 13 | Ex. 14 |
|---|---|---|---|---|
| EVA 28-06 | | | | |
| EVA 28-03 | | | | |
| EVA 12-03 | | | | |
| EVA 13-220 | | | | |
| EVA 33-43 | | | | |
| EVA 18-150 | 10 | 14 | 10 | 7 |
| EVA 08-09 | 2 | | | 3 |
| Vector ® 4111 | | | 4 | |
| (18% Styrene, SIS) | | | | |
| Kraton ® G1657 | 8 | 8 | 4 | 7 |
| (13% Styrene, SEBS) | | | | |
| Escorez ® 5400 | 51 | 51 | 53 | 54 |
| (Tackifying Resin) | | | | |
| Nyflex 222B | 27.65 | 25.65 | 27.65 | 27.65 |
| (plasticizer) | | | | |
| BNX 1010 | 0.1 | 0.1 | 0.1 | 0.1 |
| (antioxident) | | | | |
| RM-6313 | 1 | 1 | 1 | 1 |
| (processing aid) | | | | |
| ZeroPack ® Film | 0.25 | 0.25 | 0.25 | 0.25 |
| (processing aid) | | | | |
| Application | 121 | 127 | 121 | 127 |
| temperature (° C.) | | | | |
| MI of EVA (g/10 min) | 94 | 150 | 150 | 62.3 |
| Average vinyl | 16.3 | 18.0 | 18.0 | 15.0 |
| acetate % | | | | |
| % Styrene | 13.0 | 13.0 | 15.5 | 13.0 |
| Initial peel strength | 80 | 84 | 95 | 94 |
| (spiral spray) | (7) | (9) | (9) | (4) |
| (grams) | | | | |
| 2 weeks at 50° C. | 107 | | 128 | 141 |
| | (16) | | (8) | (10) |
| 4 weeks at 50° C. | 108 | | 139 | 150 |
| | (9) | | (8) | (16) |
| Initial peel strength | 86 | 93 | 81 | 76 |
| (fine line) (grams) | (7) | (13) | (6) | (9) |
| 2 weeks at 50° C. | 90 | | 88 | 117 |
| | (12) | | (10) | (20) |
| 4 weeks at 50° C. | 90 | | 92 | 126 |
| | (19) | | (7) | (29) |
| Viscosity (cps) at | | | 23,050 | 23,450 |
| 93° C. | | | | |
| Viscosity (cps) at | | | 8,475 | 10,150 |
| 107° C. | | | | |
| Viscosity (cps) at | 7,250 | 8,325 | 4,010 | 5,075 |
| 121° C. | | | | |
| Viscosity (cps) at | 4,125 | | 2,240 | 2,775 |
| 135° C. | | | | |
| Viscosity (cps) at | | 3,000 | 1,350 | 1,675 |
| 150° C. | | | | |
| % Viscosity Change | | | 6% gain | 3% gain |
| | | | (121° C.) | |
| Compatibility after | | ◯ | Θ | ◯ |
| aging at 135° C. | | | | |
| Adhesive Bleed- | 0 | | 12 | 6 |
| through | | | (8) | (8) |
| Machine Build-up | No | No | No | No |

TABLE III

| | Example 15 | Example 16 |
|---|---|---|
| EVA (18-500) | 19 | 10 |
| Kraton ® G 1657 | 20 | 14 |
| Escorez ® 5600 | 34.5 | |
| Escorez ® 5400 | | 49.5 |
| Petrolite PX-100 (wax) | | 26 |
| Pacemaker 155 (wax) | 26 | |
| Irganox 1076(antioxident) | 0.5 | 0.5 |
| Initial Values | | |
| Viscosity at 177° C. (cps) | 3100 | 1755 |
| Compatibility | ◯ | ◯ |
| Aging for 96 hours at | | |
| 177° C. | | |
| Viscosity at 177° C. (cps) | 3360 | 1670 |
| % Viscosity Change | 8.4% | 4.8% |
| Compatibility | ◯ | ◯ |
| Molten Gardner Color | 3 | 2 |
| 100 gram peel (° F.) | 117 | 156 |
| 500 gram shear (° F.) | 155 | 186 |
| Cold Cracks (° F.) | <5 | — |

What is claimed are:

1. A hot melt adhesive composition comprising:
ethylene-vinyl acetate copolymer(s) having average vinyl acetate content of from about 10% to about 30% based upon the weight of the copolymer(s);
styrene-ethylene-butylene-styrene block copolymer(s) having average styrene content of from about 10% to about 25% based upon the weight of the copolymer; and
a tackifying resin;
provided that if one of the average vinyl acetate content and the average styrene content is no less than about 20%, the other of the average vinyl acetate content and the average styrene content is no greater than about 20%.

2. The hot melt adhesive composition of claim 1, wherein said composition has a melt viscosity of no greater than 7,000 cps at a temperature of no greater than about 135° C.

3. The hot melt adhesive composition of claim 1, further comprising a plasticizer.

4. The hot melt adhesive composition of claim 1, further comprising a wax.

5. The hot melt adhesive composition of claim 1, wherein said composition exhibits no greater than about 10% change in viscosity after aging at 135° C. for a period of 96 hours.

6. The hot melt adhesive composition of claims 1, wherein said composition exhibits an initial spiral spray peel strength of no less than about 70 grams.

7. The hot melt adhesive composition of claim 1, wherein said composition exhibits an initial final line peel strength of no less than about 70 grams.

8. The hot melt adhesive composition of claim 1, wherein said ethylene-vinyl acetate copolymer has a melt index of no less than about 40 g/10 min.

9. The hot melt adhesive composition of claim 1 comprising from about 5% by weight to about 30% by weight said ethylene-vinyl acetate copolymer(s).

10. The hot melt adhesive composition of claim 1 comprising from about 3% by weight to about 20% by weight said block copolymer.

11. The hot melt adhesive composition of claim 1, comprising from about 30% by weight to about 65% by weight a tackifying resin.

12. The hot melt adhesive composition of claim 1, further comprising a styrenic block copolymer chosen from styrene-isoprene-styrene, styrene-butadiene-styrene, styrene-ethylene-butylene-styrene, and combinations thereof.

13. A hot melt adhesive composition comprising:
ethylene-vinyl acetate copolymer(s) having average vinyl acetate content of from about 10% to about 30% based upon the weight of the copolymer and a melt index of no less than 40;
styrene-ethylene-butylene-styrene block copolymer(s) having average styrene content of from about 10% to about 30% based on the weight of the copolymer; and
a tackifying resin.

14. The hot melt adhesive composition of claim 13, wherein said composition has a melt viscosity of no greater than 7,000 cps at a temperature of no greater than about 135° C.

15. The hot melt adhesive composition of claim 13, further comprising a plasticizer.

16. The hot melt adhesive composition of claim 13, further comprising a wax.

17. A hot melt adhesive composition comprising:
ethylene-vinyl acetate copolymer(s) having average vinyl acetate content of from about 10% to about 20% based upon the weight of the copolymer(s);
styrene-ethylene-butylene-styrene block copolymer having a peak weight molecular weight of no greater than about 90,000 and styrene content of from about 25% to about 30% based upon the weight of the block copolymer;
a tackifying resin; and
a plasticizer.

18. An article comprising:
a first substrate; and
a hot melt adhesive composition of claim 1 disposed on said first substrate.

19. The article of claim 18, wherein said first substrate is chosen from polyethylene film, polypropylene film, polyester film, nonwoven fabric, tissue, paper, coated paper, paper pulp fibers, and combinations thereof.

20. A method of constructing the article of claim 18, comprising contacting said first substrate with said adhesive composition.
